(19) United States
(12) Patent Application Publication
(10) Pub. No.: US 2014/0299242 A1
(43) Pub. Date: Oct. 9, 2014

(54) TREAD PATTERN FOR TIRES FOR A CIVIL ENGINEERING VEHICLE

(71) Applicant: Dominique Chauvin, Clermont-Ferrand (FR)

(72) Inventor: Dominique Chauvin, Clermont-Ferrand (FR)

(73) Assignees: MICHELIN RECHERCHE ET TECHNIQUE S.A., Granges-Paccot (CH); COMPAGNIE GERERALE DES ETABLISSEMENTS MICHELIN, Clermont-Ferrand (FR)

(21) Appl. No.: 14/233,686

(22) PCT Filed: Jun. 26, 2012
(86) PCT No.: PCT/EP2012/064741

§ 371 Date: Jun. 24, 2014

(30) Foreign Application Priority Data
Jul. 28, 2011 (FR) 1156931

(51) Int. Cl. B60C 11/03

(52) U.S. Cl. CPC B60C 11/033; B60C 11/0304
USPC 152/209.8

(57) ABSTRACT

Tyre which is provided with a carcass reinforcement which is surmounted radially at the outer side by an upper reinforcement, this upper reinforcement being formed by a stack of a plurality of reinforcement sheets, these reinforcements forming with the circumferential direction angles which are not equal to zero, this tyre comprising a tread (10) which is intended to move into contact with the ground during travel, this tread (10) comprising a plurality of cutouts which delimit relief elements in order to form a tread pattern and being such that it comprises a central portion (20) having a width between 40 and 60% of the total width of the tread and the edge portions (21) at one side and the other of this central portion, the central portion (20) being provided with a plurality of generally transversely orientated incisions (40) which are capable of closing when they move into contact, this tread being characterised in that each edge portion (21) comprises a plurality of generally transversely orientated grooves (70) which delimit a plurality of relief elements (80), the number of relief elements (80) of each edge portion being equal to the number of relief elements (50) of the central portion, this number of elements being at least 44 and a maximum of 49, and this tread has a total void ratio of a maximum of 19%.

### FIELD OF THE INVENTION

The present invention relates to tyres for heavy-duty construction site lorries (“dumpers”), those tyres being able to carry a load up to 100 tonnes, those tyres being inflated to a pressure of at least 6 bar.

### PRIOR ART

It is known to provide a tyre which is intended to provide a civil engineering works vehicle with a tread whose travel surface is provided with a tread pattern formed by a plurality of grooves which delimit relief elements (blocks, ribs) in order to generate edges of material and hollow portions. These grooves represent a hollow volume which is—in relation to the total volume of the tread—including both the volume of material and that of all the grooves and all the hollow portions—expressed as a percentage (referred to in this instance as “void ratio”). A void ratio of zero indicates a tread having neither a groove nor hollow portions.

Furthermore, the tyres are provided with a carcass reinforcement which is surmounted radially at the outer side by an upper reinforcement in order to produce a hooping of the carcass reinforcement. The upper reinforcement is generally formed by a stack of a plurality of reinforcement sheets, these reinforcements forming with the circumferential direction angles which are generally not equal to zero.

In the prior art, it is known that tread patterns for tyre treads with which vehicles of the “dumper” type are provided—these vehicles using tyres having a diameter between 2.5 m and 4 m—have the following specific dimensional features:
a mean groove depth of at least 65 mm and a maximum of 100 mm.
a mean void ratio over the whole of the tread in the order of 30% (that is to say, at least 30% and a maximum of 40%);
a central portion of tread which is slightly grooved, that is to say, whose void ratio is less than 10%, this central portion extending at one side and the other of the equatorial plane over a total width of at least 40% and a maximum of 60% of the total width of the tread;

Edge portions located at one side and the other of the central portion, these edge portions having a void ratio in the order of 40% (that is to say, at least 35% and a maximum of 44%), these edge portions comprising a plurality of blocks which are separated from each other by grooves which are generally transversely orientated.

Definitions:

A “cutout” refers in this description to either a groove or an incision and corresponds to the space delimited by walls of material which face each other and which are spaced apart from each other by a distance not equal to zero. What differentiates an incision from a groove is precisely the value of this distance; in the case of an incision, this distance is appropriate to allow the at least partial contact of the opposing walls when moving into contact with the road during normal travel conditions. In the case of a groove, the walls of this groove cannot come into contact with each other under normal travel conditions.

The surface void ratio of a tread pattern is equal to the ratio between the surface of the hollow portions (substantially formed by grooves) which are delimited by the relief elements (blocks, ribs) and the total surface (contact surface of the relief elements and surface of the hollow portions). A low surface void ratio indicates a large contact surface of the tread and a small void surface between the relief elements.

The void ratio of a tread pattern of a tread in the new state is equal to the ratio between the volume of the hollow portions (substantially formed by grooves and the incisions) and the total volume (volume of the tread including the volume of the relief elements and the total volume of the hollow portions).

A block is a relief element which is formed on a tread, this element being delimited by cutouts and comprising lateral walls and a contact face, this face being intended to move into contact with the road during travel.

A rib is a relief element which is formed on a tread, this element being delimited by two cutouts. A rib comprises two lateral walls and a contact face, the latter being intended to come into contact with the road.

A radial direction is intended to be understood to be a direction which is perpendicular to the rotation axis of the tyre (this direction corresponds to the direction of the thickness of the tread).

An axial direction is intended to be understood to be a direction parallel with the rotation axis of the tyre.

A circumferential direction is intended to be understood to be a direction which is tangential to any circle which is centred about the rotation axis. This direction is perpendicular both to the axial direction and to a radial direction.

An equatorial plane is intended to refer to the plane which is perpendicular relative to the rotation axis of the tyre, this plane extending via the radially outermost points of the tyre, this plane dividing the tyre into two equal or substantially equal halves.

The conditions for use of the tyre as defined by the E.T.R.T.O. standard stipulate the reference inflation pressure which corresponds to the load capacity of the tyre indicated by the load index and the speed code thereof. These conditions for use may be said to be nominal conditions or conditions for utilisation.

### BRIEF STATEMENT OF INVENTION

It is found that the tread patterns of treads of the prior art generate during travel, under loads per tyre which are greater than or equal to 20 tonnes and inflation pressures which are at least equal to 6 bars, a heating of the tread and an increase in the temperature of the upper reinforcement of the tyre, this increase in temperature being able in particular to lead to a reduction of the endurance of the tyre. It is, for example, possible to observe under some conditions a separation between the sheets of the upper reinforcement and a deterioration of the properties of the rubber material which surrounds the reinforcements of these sheets.

The need has been set out for having tread patterns of a tread which reduce the heating, while retaining the properties which are indispensable for the requirements for use under conditions as set out above. To this end, the invention relates to a tyre with which a civil engineering works vehicle (“dumper”) is intended to be provided in order to carry a load of at least 20 tonnes and which is inflated to at least 6 bars, this tyre being provided with a carcass reinforcement which is surmounted radially at the outer side by an upper reinforcement, this upper reinforcement being formed by a stack of a plurality of reinforcement sheets, these reinforcements forming with the circumferential direction angles which are not equal to zero. The tread of this tyre comprises a plurality of cutouts which delimit relief elements in order to form a tread pattern, according to which:
the tread comprises a central portion having a width between 40 and 60% of the total width of the tread and the edge portions at one side and the other of this central portion, the central portion being delimited axially by generally circumferentially orientated incisions, these incisions having a depth and a width which are appropriate so that they close when they move into contact;
the central portion being provided with a plurality of generally transversely orientated incisions which open in the circumferential incisions which delimit the central portion, these generally transversely orientated incisions delimiting rows of elements which are arranged circumferentially and being capable of closing when they move into contact;
each edge portion comprises a plurality of generally transversely orientated grooves which delimit a plurality of relief elements, the number of relief elements of each edge portion being equal to the number of relief elements of the central portion, this number of elements being at least 44 and a maximum of 53. The number of relief elements is counted as being the number of elements which follow each other in the circumferential direction, regardless of the portion of the tread being considered.

Furthermore, this tread has a total mean void ratio of a maximum of 19%, the total mean void ratio corresponding to the ratio between the volume of all the hollow portions present which in the new state open at the travel surface of the tread and the total volume of the tread.

Advantageously, the total void ratio of the central portion is a maximum of 15%.

Advantageously, the number of elements counted in the circumferential direction is at least 45 and a maximum of 49, these elements having the same circumferential dimension or substantially the same circumferential dimension.

Preferably, the void ratio of the central portion is a maximum of 10% and that of each edge portion is a maximum of 30%, the void ratio of each edge portion being greater than the mean void ratio of the central portion. The void ratio of a portion of the tread corresponds to the ratio between the volume of all the hollow portions present in the new state on that tread portion and the total volume of the tread portion (including the volume of all the hollow portions).

The hollow portions of the tread pattern in the central portion of the tread are formed by means of incisions, these incisions having the specific feature of being able to close when moving into contact with a road and to open without any contact in order to ensure a ventilation of the relief elements. The closure of the incisions is determined by their width, the compression modulus of the material of the tread and the load and pressure conditions of the tyre. The width of the incisions is selected so that this width is at least 3% and a maximum of 5% of the mean length measured in the circumferential direction of the relief element of the central portion. Closure of the incisions is intended in this instance to be understood to mean that the walls which delimit these incisions move closer to each other when moving into contact with the road so as to be at least partially in contact one on the other.

As a result of the tread pattern according to the invention, it is possible to reduce significantly the heating of the materials which constitute the tyre in each portion of the tyre, whilst retaining a high performance level.

In order to further increase this effect of reducing the heating, it is advantageous to provide the central portion with at least one generally circumferentially orientated incision, this incision having a depth which is equal to or similar to the depth of the incisions which axially delimit the central portion.

Preferably, the reinforcements of the carcass reinforcement are arranged so as to be orientated radially, that is to say, so as to form an angle equal to or similar to 90 degrees with the circumferential direction.

As a result of a tread according to the invention, the ventilation of the tread is made much more efficient than with tread patterns of treads of the prior art by means of the presence of a larger number of ventilation zones which are distributed in a uniform manner and formed by the multiple incisions of the central portion and the presence of a larger number of relief elements on this same central portion.

Consequently, the heating of the structure is reduced, which allows greater endurance and higher travel speeds, a factor which is particularly advantageous for this type of tyre of works machines. This configuration of a tread pattern in the new state enables an increase of the volume of rubber to be worn and therefore an increase of the service-life of the product. Furthermore, as a result of the closure of the incisions, it is possible to maintain a level of rigidity appropriate for the portion of the tread which comes into contact with a road, this rigidity being similar to that of a tread which has almost no cutouts.

A void ratio limited to 17% necessarily leads to less contact pressure on the ground for similar load and pressure conditions and consequently to fewer thermal sources—compared with a tyre of the prior art, which is essential for treads having a large volume of material, as is precisely the case for treads which are intended for tyres of civil engineering vehicles.

Preferably, and in order to limit the flexion deformations of the blocks, they have dimensions (length, width) in terms of surface which are at least equal to twice their height, which substantially reduces the flexion deformations of the blocks when moving into contact with the ground. The dimensions given are measured in the circumferential and transverse directions.

Furthermore, these dimensions of the blocks are a maximum of two and a half times their height. As a result of this specific range of values (greater than twice the height and less than two and a half times the same height), the blocks are rather urged to carry out a shearing action and have a lower thermal resistance, which allows them to even more easily discharge the heat produced under the harsh travel conditions at the centre of the patterns.

It should be noted that the reduction of the thermal level in the tread allows the thermal level in the upper reinforcement to be reduced by the same proportions, which is of course advantageous from a point of view of the endurance of this reinforcement. This allows the period of use of a tyre provided with such a tread to be increased substantially under conditions of use as set out above.

The tread pattern according to the invention allows a comparatively greater volume of material to be worn to be put in the tyres of the same category and the same use of the prior art and thus allows the performance in terms of wear to be increased by at least 10% (with the same number of kilometres of use, the loss of material by means of wear is at least 10% less than the loss which was obtained with a tread according to the prior art.

Other features and advantages of the invention will be appreciated from the description given below with reference to the appended drawings which illustrate by way of non-limiting examples variants of the subject-matter of the invention.

### BRIEF DESCRIPTION OF THE FIGURES

FIG. 1 is a view of the surface of a first variant of a tread according to the invention;

FIG. 2 shows a second variant of the pattern of a tread pattern of a tread according to the invention.

### DESCRIPTION OF THE FIGURES

For the Figures which accompany this description, the same reference numerals can be used in order to describe variants of the invention since these reference numerals refer to elements of the same type, whether this be of the structural or functional type.

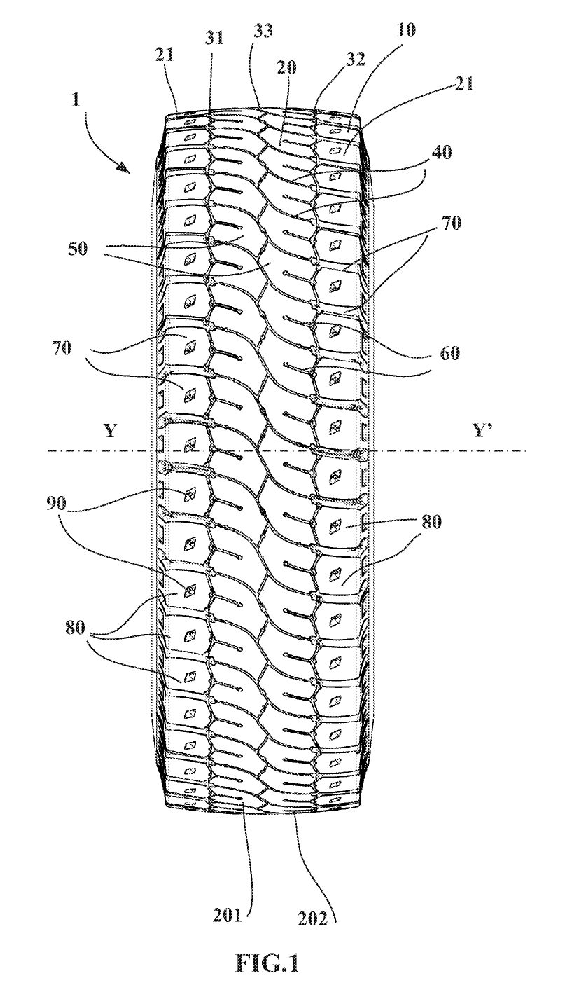

FIG. 1 shows a tyre 1 of the size 40.00 R57 comprising a tread 10 according to a first variant of the invention. This tyre is intended to be provided on a vehicle of the “dumper” type. The outer diameter measured at the equatorial plane (plane perpendicular relative to the rotation axis which extends via the radially outermost points of the tread) for this tyre is 3500 mm.

This tyre comprises a radial carcass reinforcement, that is to say, whose reinforcements are orientated so as to form an angle equal to or similar to 90 degrees with a circumferential direction.

This tyre further comprises radially at the outer side of the carcass reinforcement an upper reinforcement which is formed by a stack of five sheets, each sheet comprising reinforcements which are arranged in directions other than the circumferential direction and which are arranged crosswise from one sheet to the adjacent sheet. This upper reinforcement is itself surmounted by a tread having a mean thickness E in the present case of 130 mm).

The tread 10 is divided in the transverse or axial direction (that is to say, in a direction YY′ parallel with the rotation axis of the tyre) into a central portion 20—which is delimited axially by two circumferential incisions 31, 32—and edge portions 21 located at one side and the other of the central portion 20. The generally circumferentially orientated incisions 31, 32 which delimit the central portion have a mean width of 10 mm and a mean depth of 100 mm. These incisions are capable of closing when moving into contact with the ground and opening without contact in order to allow both appropriate rigidity of the central portion in contact and suitable ventilation without contact.

The central portion 20 has a width of 525 mm, representing 55% of the total width of the tread 10 which is equal to 950 mm in this case.

Furthermore, the central portion 20 is provided with an incision 33 having a generally circumferential zig-zag orientation and a plurality of generally transversely orientated incisions 40; the circumferential incisions 31, 32, 33 and transverse incisions 40 have a mean depth of 100 mm and a mean width of 10 mm. The transverse incisions 40 extend over the entire width of the central portion to open in the circumferential incisions 31, 32 which delimit the central portion 20.

These incisions cut out a plurality of blocks 50 which are arranged in two circumferential rows 201, 202. Furthermore, each block 50 is provided with a transverse incision 60 which opens only at one side of the blocks 50.

Each edge portion 21 comprises a plurality of generally transversely orientated grooves 70 having a mean width of 50 mm and a mean depth of 100 mm. These transverse grooves 70 are positioned in the continuation of the transverse incisions 40 of the central portion. These transverse grooves delimit a plurality of blocks 80 whose mean circumferential length is substantially equal to the mean circumferential length of the blocks of the central portion.

Over a wheel turn, the total number of blocks 50, 80 in the central portion 20 and in each of the edge portions 21 is 44, respectively.

This tread has a total void ratio (calculated over the entire thickness E of the tread) in this instance of 18.75%.

Furthermore, the void ratio of the central portion 20 in this instance is 8%, while the void ratio of each edge portion 21 is 22%.

On each edge portion 21, there is further provision for the presence of cavities 90 having a depth of 40 mm and having a volume in the order of 62 cm³. These cavities increase the ventilation of the edge portions. It should be noted that they could be omitted, the ratios of hollow portions selected for the central portion and for the edge portions being sufficient to ensure a better mechanical and thermal function of the blocks.

In the example described, the minimum dimension of the blocks in the longitudinal direction is greater than the depth of the grooves—in this instance, this minimum dimension is 200 mm in order to limit the appearance of irregular occurrences of wear, that is to say, occurrences of wear which would be localised at specific portions of the tread and not occurrences of wear which are distributed in a homogeneous manner over the entire travel surface of the tread.

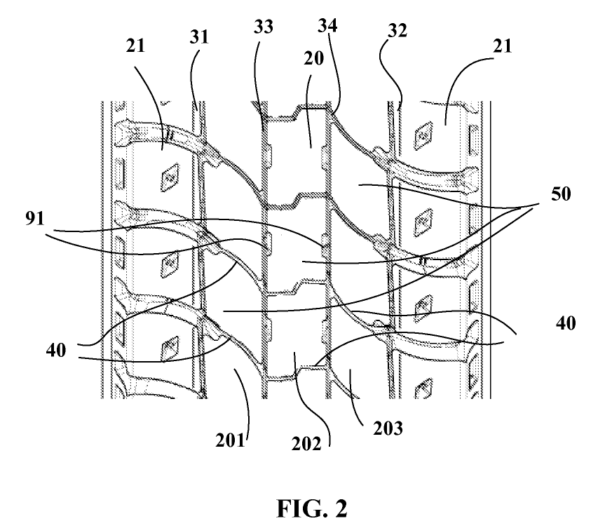

FIG. 2 shows another variant of a tread pattern of a tread according to the invention.

According to this variant, the central portion is delimited axially at the outer side by circumferential incisions 31, 32. This same central portion 20 comprises two rectilinear additional circumferential incisions 33, 34 in order to delimit three rows 201, 202, 203. The additional circumferential incisions 33, 34 extend through a plurality of cavities 91 which are intended to increase the ventilation of the central portion.

Furthermore, each of these rows is provided with a plurality of incisions 40 which are orientated transversely in order to delimit a plurality of blocks 50.

This second variant of the invention has a total void ratio over the tread of 15%. The void ratio of the central portion in this instance is 10%.

Over a wheel turn, the total number of relief elements in the central portion and in each of the edge portions is 45.

Although the invention has been described in a general manner and by means of two variants, it must be understood that this invention is not limited to these variants alone. It is clear that various modifications may be carried out thereto without departing from the general scope of the present invention. In particular, the cavities provided on the blocks of the edge portions in these two variants may be omitted in order to bring more material into contact with the ground.

1. A tread for a tire for tire civil engineering works, the tire comprising a carcass reinforcement which is surmounted radially at the outer side by an upper reinforcement, this upper reinforcement being formed by a stack of a plurality of reinforcement sheets, these reinforcements forming circumferential direction angles which are not equal to zero, the tread comprising:
a travel surface which is intended to move into contact with ground during travel,
a plurality of cutouts which delimit relief elements forming a tread pattern on the travel surface, the tread pattern comprising:
a central portion having a width between 40 and 60% of a total width of the tread, and
edge portions at one side and the other of this central portion,
wherein the central portion is delimited axially by generally circumferentially orientated incisions these incisions having a depth and a width which are appropriate so that they can close when they move into contact,
wherein the central portion is provided with a plurality of generally transversely orientated incisions which open in the circumferential incisions which delimit the central portion, these generally transversely orientated incisions delimiting rows of elements which are arranged circumferentially and being capable of closing when they move into contact, wherein:
each edge portion comprises a plurality of generally transversely orientated grooves which delimit a plurality of relief elements,
the number of relief elements of each edge portion, counted in the circumferential direction is equal to the number of relief elements of the central portion, this number of elements being at least 44 and at most 53, and
the tread has a total mean void ratio of at most 19%, the total mean void ratio corresponding to the ratio between the volume of all the hollow portions which in the new state open at the travel surface of the tread and the total volume of the tread.

2. The tread according to claim 1, wherein the total mean void ratio is at most 15%.

3. The tread according to claim 1, wherein the number of elements counted in the circumferential direction is at least 45 and at most of 49.

4. The tread according to claim 1, wherein the mean void ratio of the central portion is at most 10% and that of each edge portion is at most 30%, the mean void ratio of each edge portion being greater than the void ratio of the central portion.

5. The tread according to claim 1, wherein the central portion further comprises at least one generally circumferentially orientated incision, this incision having a depth equal to or similar to the depth of the incisions which axially delimit the central portion.

6. The tread according to claim 1, wherein the reinforcements of the carcass reinforcement are arranged so as to be orientated radially, that is to say, so as to form an angle equal to or similar to 90 degrees with the circumferential direction.

7. The tread according to claim 1, wherein the relief elements of the tread have surface dimensions which are at least equal to two times the height thereof, this height being measured as the mean depth of the incisions which delimit the relief elements.

8. The tread according to claim 7, wherein the relief elements of the tread have surface dimensions which are a maximum of two and a half times the height thereof.

9. The tread according to claim 1, wherein the width of the incisions of the central portion of the tread is at least 3% and at most 5% of a mean length, measured in the circumferential direction, of each relief element of the central portion.

10. A tire which is intended to be provided on a vehicle for civil engineering works, comprising a tread according to claim 1.
